(19) United States
(12) Patent Application Publication
(10) Pub. No.: US 2016/0250905 A1
(43) Pub. Date: Sep. 1, 2016

(54) VEHICLE SEAT AIR-CONDITIONER

(71) Applicant: DENSO CORPORATION, Kariya-city, Aichi (JP)

(72) Inventors: Yuusuke TANAKA, Kariya-city (JP); Yasuhiko NIIMI, Kariya-city (JP); Takahisa FUJII, Kariya-city (JP)

(21) Appl. No.: 15/030,454

(22) PCT Filed: Oct. 14, 2014
(86) PCT No.: PCT/JP2014/005197

§ 371 Date: Apr. 19, 2016

(30) Foreign Application Priority Data
Oct. 25, 2013 (JP) 2013-222118

(51) Int. Cl. B60H 1/00; B60N 2/56

(52) U.S. Cl. CPC B60H 1/00285; B60H 1/00842; B60H 1/00678; B60H 1/00871; B60H 1/00564; B60N 2/5657

(57) ABSTRACT

A controller causes a blowout air switching device to switch an air blowout portion to a first blowing state if air blown from the air blowout portion is in a pre-temperature controlled state. If air blown from the air blowout portion is in a temperature controlled state, the controller causes the blowout air switching device to switch the air blowout portion to a second blowing state. Furthermore, in the first blowing state, a first air outlet is opened while a second air outlet is closed. Conversely, in the second blowing state, the first air outlet is closed while the second air outlet is open. Thus, it is possible to avoid blowing insufficiently temperature controlled air against a seated occupant, without having to suppressed the blowout airflow rate when a seat air-conditioner starts air-conditioning.

### CROSS-REFERENCE TO RELATED APPLICATION

The present application is based on Japanese patent application No. 2013-222118 filed on Oct. 25, 2013, the content of which is incorporated herein by reference.

### TECHNICAL FIELD

The present disclosure relates to a vehicle seat air-conditioner that blows out conditioned air in a vehicle seat.

### BACKGROUND ART

As a conventional technology related to vehicle seat air-conditioners, for example Patent Literature 1 discloses a vehicle seat air-conditioner that blows out conditioned air from a plurality of micro holes formed on a seat surface. According to the vehicle seat air conditioner of Patent Literature 1, when starting seat air-conditioning while the vehicle cabin interior is being cooled down or warmed up, a blowout airspeed from the seat surface is limited such that the blowout airspeed is 0.4 m/s or lower.

### PRIOR ART LITERATURE

### Patent Literature

Patent Literature 1: JP 2001-307731 A

### SUMMARY OF THE INVENTION

When starting seat air-conditioning, there is a large amount of heat loss in a ventilation passage from a heat exchanger, which heats or cools air, to an air outlet. Accordingly, the blowout air is insufficiently temperature controlled. Due to this, there is a concern that a passenger, who is sitting on the vehicle seat and is being blown by this blowout air, may be discomforted. In this regard, according to the vehicle seat air-conditioner of Patent Literature 1, the insufficiently conditioned air is blown weakly, so as to reduce the discomfort of the passenger.

However, according to the vehicle seat air-conditioner of Patent Literature 1, during the period that the blowout air is insufficiently temperature controlled, the airflow rate of the air passing through the ventilation passage is low. Accordingly, the amount of heat transferred from that air to the ventilation passage per unit of time is low. For this reason, there is a concern that the temperature of ventilation passage may not readily reach the temperature of the air flowing through the ventilation passage. As such, there is a concern that a longer amount of time may be needed for the air temperature blown against the passenger to reach a sufficiently temperature controlled temperature.

In view of the above points, it is an object of the present disclosure to provide a vehicle seat air-conditioner capable of maintaining the comfort of a passenger seated on the vehicle seat, without needing to suppress a blowout airflow rate when starting air-conditioning.

According to a first aspect of the present disclosure, vehicle seat air-conditioner comprises a ventilator that blows air, a heat exchanger that heats or cools the air blown by the ventilator, an air blowout portion that blows out air guided from the heat exchanger, the air blowout portion opening into a vehicle cabin, a first switching device that switches the air blowout portion between a first blowing state, in which air is blown from the air blowout portion so as to avoid a passenger space, the passenger space occupying above a passenger support surface of a vehicle seat that supports a passenger, and a second blowing state, in which air is blown from the air blowout portion toward the passenger space, and a controller that causes the first switching device to switch the air blowout portion to the first blowing state when the air blown from the air blowout portion is in a pre-temperature controlled state of prior to reaching a predetermined temperature controlled state, and causes the first switching device to switch the air blowout portion to the second blowing state when the air blown from the air blowout portion is in the temperature controlled state.

According to the first aspect, the controller causes the first switching device to switch the air blowout portion to the first blowing state when the air blown from the air blowout portion is in the pre-temperature controlled state, and causes the first switching device to switch the air blowout portion to the second blowing state when the air blown from the air blowout portion is in the temperature controlled state. Accordingly, it is possible to avoid blowing insufficiently temperature controlled air against a seated occupant, without having to suppressed the blowout airflow rate when starting air-conditioning. For this reason, the comfort of a passenger sitting on the vehicle seat may be maintained.

### BRIEF DESCRIPTION OF THE DRAWINGS

FIG. 1 is an outline perspective view showing a vehicle seat air-conditioner of a first embodiment and a vehicle seat having that vehicle seat air-conditioner installed.

FIG. 2 is a perspective view of the vehicle seat of FIG. 1 that shows the vehicle seat in an easy to see manner.

FIG. 3 is a cross sectional view along III-III of FIG. 1 in a first embodiment, and is a cross sectional view showing a seat cushion and a seat air-conditioner.

FIG. 4 is a cross sectional view along III-III of FIG. 1 in a first embodiment, and shows a second air outlet in an opened state.

FIG. 5 is a flow chat shows control processing of a controller of FIG. 3.

FIG. 6 is a cross sectional view of a seat cushion and a seat air-conditioner of a second embodiment, and corresponds to FIG. 3 of the first embodiment.

FIG. 7 is a cross sectional view of a seat cushion and a seat air-conditioner of a second embodiment, and corresponds to FIG. 4 of the first embodiment.

FIG. 8 is a cross sectional view of a seat cushion and a seat air-conditioner of a third embodiment, and corresponds to FIG. 3 of the first embodiment.

FIG. 9 is a cross sectional view of a seat cushion and a seat air-conditioner of a third embodiment, and corresponds to FIG. 4 of the first embodiment.

FIG. 10 is a cross sectional view of a seat cushion and a seat air-conditioner of a fourth embodiment, and corresponds to FIG. 3 of the first embodiment.

FIG. 11 is a cross sectional view of a seat cushion and a seat air-conditioner of a fourth embodiment, and corresponds to FIG. 4 of the first embodiment.

FIG. 12 is a cross sectional view of a seat cushion and a seat air-conditioner of a fifth embodiment, and corresponds to FIG. 10 of the fourth embodiment.

FIG. 13 is a cross sectional view of a seat cushion and a seat air-conditioner of a fifth embodiment, and corresponds to FIG. 11 of the fourth embodiment.

FIG. 14 shows characteristics of a sixth embodiment, and is a cross sectional view of an air blowout portion and an air suction portion along an airflow.

FIG. 15 is a plane view showing an air blowout portion and an air suction portion of FIG. 14 from the top.

FIG. 16 is a cross sectional view along XVI-XVI of FIG. 14.

FIG. 17 is a cross sectional view of an air blowout portion and an air suction portion showing airflow when a suction force of a ventilator is not applied to an intake ventilation pipe and air is blown out form an air blowout portion in a sixth embodiment.

FIG. 18 shows a first modified example of an air blowout portion and an air suction portion shown in FIG. 16.

FIG. 19 shows a second modified example of an air blowout portion and an air suction portion shown in FIG. 16.

### EMBODIMENTS FOR CARRYING OUT INVENTION

Hereinafter, embodiments of the present disclosure will be explained with reference to the figures. Further, in each of the embodiments below, portions which are the same or equal to each other are denoted with the same reference numerals in the figures.

### First Embodiment

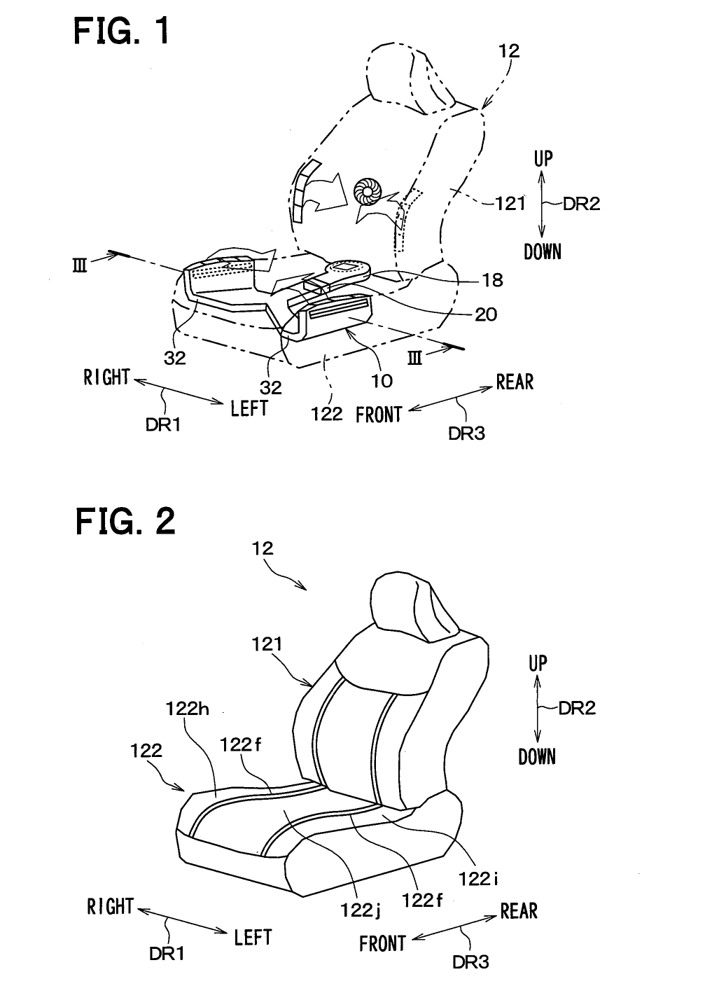

FIG. 1 is an outline perspective view showing a vehicle seat air-conditioner 10 of the present embodiment, and showing a vehicle seat 12 having the vehicle seat air-conditioner 10 installed. Each of a seat back 121 and a seat cushion 122 of the vehicle seat 12 has a vehicle seat air-conditioner installed. The vehicle seat air-conditioner 10 of the present disclosure (hereinafter, simply “seat air-conditioner 10”) is a vehicle seat air-conditioner installed in the seat cushion 122. Further, in FIG. 1, the directional market DR1 shows a left-right direction DR1 of the vehicle, i.e., is a vehicle width direction DR1. The directional market DR2 shows an up-down direction DR2 of the vehicle, i.e., is a vehicle vertical direction DR2. The directional market DR3 shows a front-rear direction of the vehicle, i.e., is a vehicle longitudinal direction DR3

The vehicle seat 12 shown in FIG. 1 includes the seat back 121 and the seat cushion 122. A passenger sitting on the vehicle seat 12, i.e., a seat occupant, leans against the seat back 121. The seat cushion 122 functions as a seat portion for the seat occupant and supports the buttocks and thigh region 14 of the seat occupant. The vehicle seat 12 is symmetrically shaped in the vehicle width direction DR1.

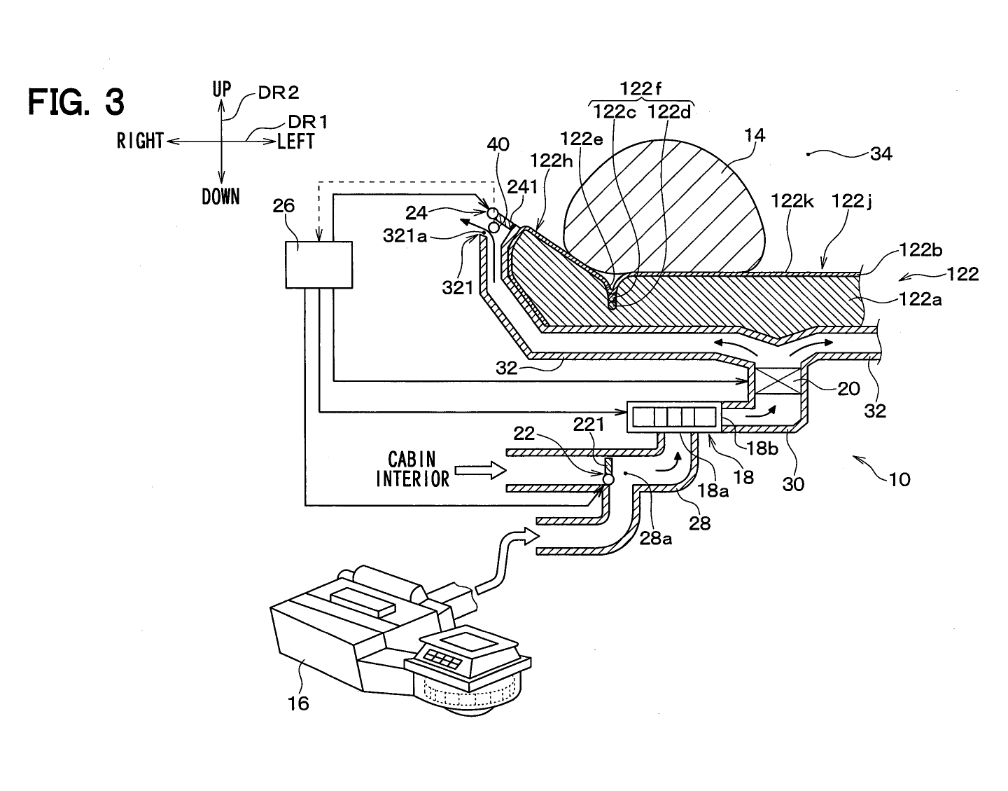

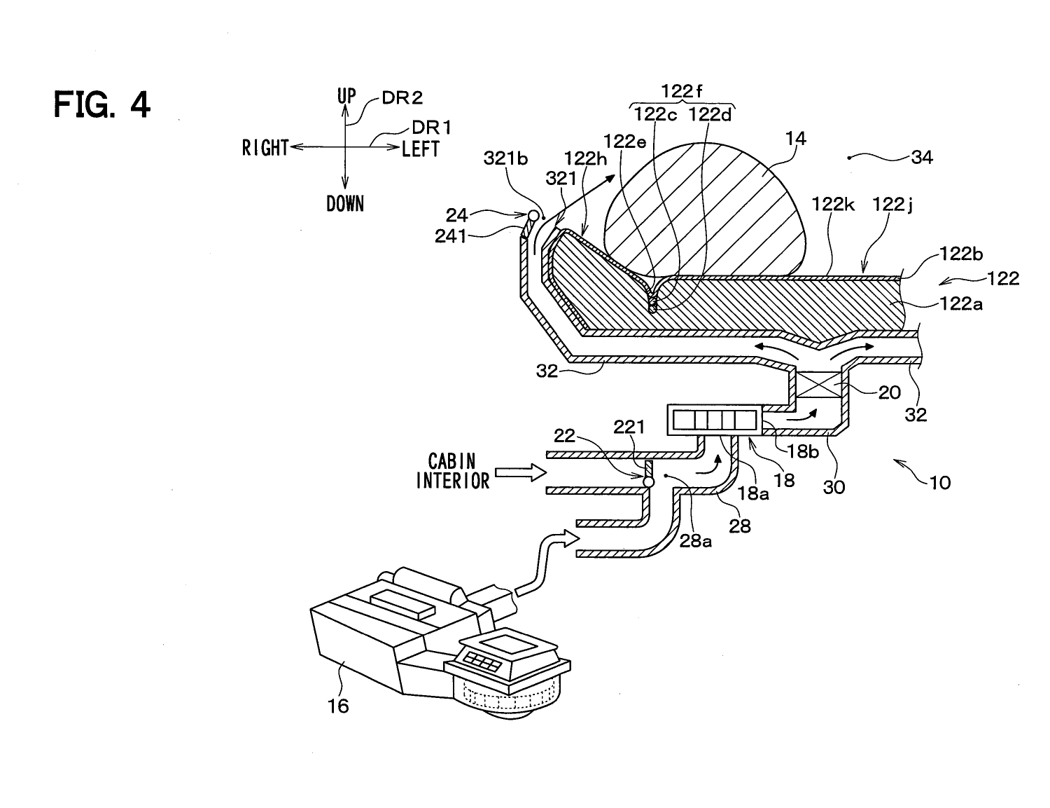

FIG. 2 is a perspective view of the vehicle seat 12 showing the vehicle seat 12 in an easy to see manner. FIG. 3 is a cross section view along III-III of FIG. 1, and is a cross section view of the seat cushion 122 and the seat air-conditioner 10. In FIG. 3, the thigh region 14 of the seated occupant on the seat cushion 122 is shown in a cross section view. Further, since the seat cushion 122 and the seat air-conditioner 10 are substantially symmetrically shaped in the vehicle width direction DR1, in FIG. 3, the left half of the vehicle in the vehicle width direction DR1 is omitted from illustration. This omission in illustration also applies to FIGS. 4 and 6 to 13 described later.

As shown in FIGS. 2 and 3, the seat cushion 122 of the vehicle seat 12 includes a seat pad 122a of elastic polyurethane foam and a seat cover 122b that covers the occupant side of the seat pad 122a.

The seat cover 122b is sewed in a three-dimensional manner along the outer shape of the seat pad 122a, and follows the outer shape of the seat pad 122a with an upholstery structure. The upholstery structure suspends the seat cover 122b in an upholstery groove 122e formed on the surface of the seat pad 122a by locking an upholstery wire 122c, which is disposed on the reverse side of the seat cover 122b, with an insert wire 122d, which is buried in the seat pad 122a.

This upholstery wire 122c and the insert wire 122d form an upholstery portion 122f. As shown in FIG. 2, a pair of the upholstery portion 122f is disposed along the vehicle width direction DR1. Each upholstery portion 122f is formed to extend in the vehicle longitudinal direction DR3 along the outer shape of the occupant side of the seat cushion 122. Further, as shown in FIG. 3, the upholstery portion 122f function as cover joining portions which join the seat cover 122b to the seat pad 122a.

As shown in FIG. 2, the occupant side surface of the seat cushion 122 is formed of three parts which are lined up along the vehicle width direction DR1. These three parts include a right side seat peripheral portion 122h, a left side seat peripheral portion 122i, and a center seat portion 122j interposed between the seat peripheral portions 122h, 122i. The two seat peripheral portions 122h, 122i are symmetrically shaped with the center seat portion 122j interposed thereinbetween. A passenger support surface 122k (refer to FIG. 3) is formed on the occupant side of the center seat portion 122j. The passenger support surface 122k supports the occupant, i.e., a passenger. In other words, the center seat portion 122j is a passenger support portion that directly contacts the passenger to support the passenger.

The right side seat peripheral portion 122h is adjacent to the center seat portion 122j through one of the pair of upholstery portions 122f in the vehicle width direction DR1. Further, the left side seat peripheral portion 122i is adjacent to the center seat portion 122j through the other one of the pair of upholstery portions 122f in the vehicle width direction DR1. Further, the structure of the seat back 121 is the same as the above described structure of the seat cushion 122.

As shown in FIGS. 1 and 3, the seat air-conditioner 10 is disposed in the vehicle seat 12, and is arranged from below the seat cushion 122 to the sides. The seat air-conditioner 10 is an air-conditioner that intakes air from a vehicle cabin interior air-conditioner unit 16 or air inside the vehicle cabin. This air is heated, and the seat air-conditioner 10 blows the warm air from either side of the seat cushion 122 in the vehicle width direction DR1 toward the left and right thigh regions 14 of the seated occupant. In other words, the seat air-conditioner 10 is an air-conditioner that blows warm air from around the vehicle seat 12 toward the seated occupant. Further, the vehicle cabin interior air-conditioner unit 16 is a typical air-conditioner unit disposed in an instrument panel, and includes an evaporator and a heater core. Then, by circulating a coolant which is heated or cooled by a heat exchanger disposed outside the vehicle cabin, the vehicle cabin interior air-conditioner unit 16 air-conditions the vehicle cabin.

As shown in FIG. 3, the seat air-conditioner 10 includes a ventilator 18, a heat exchanger 20, an intake air switching device 22, a blowout air switching device 24, ventilation pipes connecting these elements, and a controller 26. The ventilator 18 is an electric centrifugal blower that intakes air from an air inlet 18a and blows out air from an air outlet 18b. The ventilator 18 rotates and ventilates according to a control signal form the controller 26.

The air inlet 18a of the ventilator 18 is connected to one end of an intake ventilation pipe 28. The intake air switching device 22 is disposed in the other end of the intake ventilation pipe 28. The intake air switching device 22 includes a pivot door 221 and an actuator that rotates the pivot door 221 according to a control signal from the controller 26.

The other end of the intake ventilation pipe 28 is an air intake portion 28a. The intake air switching device 22 switches the air intake portion 28a between a first intake state and a second intake state according to the pivot position of the pivot door 221. In the first intake state, air in the vehicle cabin may be introduced into the intake ventilation pipe 28, while air from the vehicle cabin interior air-conditioner unit 16 is blocked. In the second intake state, air is blocked from being introduced from inside the vehicle cabin, while air from the vehicle cabin interior air-conditioner unit 16 may be introduced into the intake ventilation pipe 28. In this regard, either the air in the vehicle cabin or the air from the vehicle cabin interior air-conditioner unit 16 is guided to the air inlet 18a of the ventilator 18. The air from the vehicle cabin interior air-conditioner unit 16 may be, for example, be guided from a pipe that branches from a pipe connected to a foot outlet of the vehicle cabin interior air-conditioner unit 16. This air is air-conditioned air that passed through the evaporator in the vehicle cabin interior air-conditioner unit 16.

The heat exchanger 20 is a heating heat exchanger that heats the air blown by the ventilator 18, and may be, for example, a PTC heater. Specifically, such a PTC heater includes an electrical resistor having a positive temperature-resistance characteristic in which an electrical resistance value increases rapidly at a predetermined temperature. A relay ventilation pipe 30 is disposed between the heat exchanger 20 and the air outlet 18b of the ventilator 18. The air intake side of the heat exchanger 20 is connected to the air outlet 18b of the ventilator 18 through the relay ventilation pipe 30.

The air outflow side of the heat exchanger 20 is connected to a blowout ventilation pipe 32. The blowout ventilation pipe 32 branches out toward either side in the vehicle width direction DR1. An end of the blowout ventilation pipe 32 opposite from the heat exchanger 20 forms an air blowout portion 321 that opens into the vehicle cabin. The air blowout portion 321 blows out air guided from the heat exchanger 20. Further, the air blowout portion 321 is disposed outward of the seat cushion 122 in the vehicle width direction DR1. In addition, the intake ventilation pipe 28, the relay ventilation pipe 30, and the blowout ventilation pipe 32 may constitute a duct member integrally formed by resin.

A first air outlet 321a and a second air outlet 321b are formed in the air blowout portion 321 (refer to FIG. 4). The first air outlet 321a opens outward in the vehicle width direction DR1. The second air outlet 321b opens in a diagonally upward direction toward the seat cushion 122. FIG. 4 is, like FIG. 3, a cross section view along III-III of FIG. 1, but unlike FIG. 3, shows a state in which the second air outlet 321b is open. Further, FIG. 3 shows a state in which the first air outlet 321a is open.

The blowout air switching device 24 is disposed in the air blowout portion 321. The blowout air switching device 24 includes a pivot door 241 and an actuator that rotates the pivot door 241 according to a control signal from the controller 26. The blowout air switching device 24 corresponds to a first switching device of the present disclosure.

The blowout air switching device 24 switches the air blowout portion 321 between a first blowing state and a second blowing state according to a pivot position of the pivot door 241. In the first blowing state, the first air outlet 321a is open while the second air outlet 321b is closed. In the second blowing state, the first air outlet 321a is closed while the second air outlet 321b is open. In the air blowout portion 321, the first air outlet 321a is opened when switched to the first blowing state. Accordingly, air is blown out from the first air outlet 321a so as to avoid a passenger space 34. The passenger space 34 occupies above the passenger support surface 122k of the center seat portion 122j (refer to FIG. 3). In other words, air is blown toward a direction away from the passenger space 34, i.e., in a direction not toward the passenger space 34. Conversely, in the air blowout portion 321, the second air outlet 321b is opened when switched to the second blowing state. Accordingly, air is blown out toward the passenger space 34. Further, the above described passenger space 34 means a three-dimensional range included above the passenger support surface 122k, and therefore does not change whether a seated occupant is or is not on the passenger support surface 122k.

The controller 26, shown in FIG. 3, is an electronic control unit comprising a well known microcomputer and surrounding circuitry. The microcomputer is formed of a CPU, ROM, RAM, the and like. The controller 26 performs a variety of control processes according to computer programs pre-recorded on the ROM and the like.

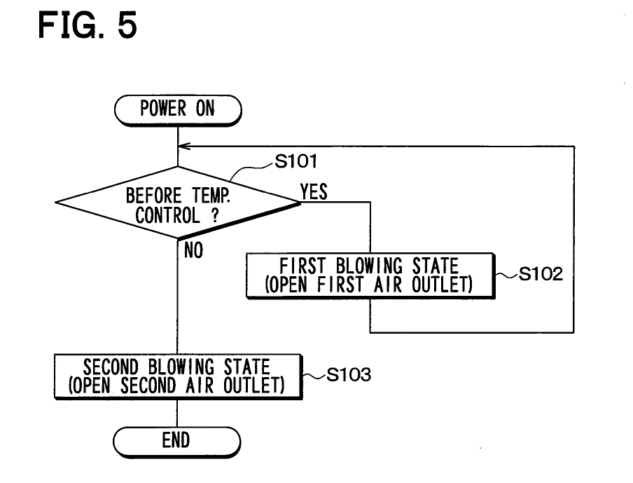

The seat air-conditioner 10 includes various sensors typically included in seat air-conditioners, including a blowout temperature sensor 40. The blowout temperature sensor 40 is disposed in the air blowout portion 321 of the blowout ventilation pipe 32, and detects a blowout air temperature Tspt, i.e., a temperature of the air being blown out from the blowout ventilation pipe 32. Detection signals from sensors such as the blowout temperature sensor 40 are sequentially input into the controller 25. The controller 26 performs a variety of air-conditioning controls by causing the ventilator 18, the heat exchanger 20, the intake air switching device 22, and the blowout air switching device 24 to operate. For example, the controller 26 performs the control process of FIG. 5, described below.

FIG. 5 is a flowchart showing a control process of the controller 26. For example, when a seat air-conditioning switch, which is operated by a passenger and is not illustrated, is switched on, the seat air-conditioner 10 becomes active. Then, the controller 26 causes the ventilator 18 to start blowing air and the heat exchanger 20 to begin heating the ventilation air. At the same time, the controller 26 performs the control process shown in the flowchart of FIG. 5. At this time, the controller 26 allows the intake air switching device 22 to switch the air intake portion 28a of the intake ventilation pipe 28 to either of the first intake state and the second intake state. Further, aside from the seat air-conditioning switch described above, an airflow rate setting switch, which is not illustrated and is operated by the passenger, is provided. The controller 26 controls the rotation speed of the ventilator 18 such that the airflow rate blown by the ventilator 18 becomes the set airflow rate set by the airflow rate setting switch.

First, at S101 of FIG. 5, the controller 26 obtains the blowout air temperature Tspt from the detection signal of the blowout temperature sensor 40. Then, the controller 26 determines whether a pre-temperature controlled state exists, in which the air being blown out from the air blowout portion 321 has yet to reach a predetermined temperature controlled state. The temperature controlled state is a temperature controlled state of air which is set by prior experimentation. Specifically, the temperature controlled state is a state in which the blowout air temperature Tspt is at or above a temperature threshold T1spt which is set by prior experimentation. Then, the pre-temperature controlled state is a state from when the heat exchanger 20 begins heating the ventilation air and prior to reaching the temperature controlled state. Specifically, the pre-temperature controlled state is a state in which the blowout air temperature Tspt is below the temperature threshold T1spt. In other words, the controller 26 is configured to, when the blowout air temperature Tspt is at or above the temperature threshold T1spt, determine that the air being blown from the air blowout portion 321 is in the temperature controlled state. Conversely, the controller 26 determines that the air is in the pre-temperature controlled state when the blowout air temperature Tspt is below the temperature threshold T1spt.

At S101, if it is determined that the air being blown out from the air blowout portion 321 is in the pre-temperature controlled state, the process continues to S102. Conversely, if it is determined that the air being blown out from the air blowout portion 321 is not in the pre-temperature controlled state, i.e., the air is in the temperature controlled state, the process continues to S103.

At S102, the blowout air switching device 24 is caused to switch the air blowout portion 321 to the first blowing state shown in FIG. 3. The controller 26 controls the rotation speed of the ventilator 18 such that the airflow rate of the ventilator 18 becomes the set airflow rate of the airflow rate setting switch even when the air being blown out from the air blowout portion 321 is determined to be in the pre-temperature controlled state.

After S102, the process returns to S101. In other words, while the air being blown out from the air blowout portion 321 is determined to be in the pre-temperature controlled state, the air blowout portion 321 continues the first blowing state.

At S103, the blowout air switching device 24 is caused to switch the air blowout portion 321 to the second blowing state shown in FIG. 3. After S103 is complete, then normal air-conditioning controls performed by typical seat air-conditioners are performed. These normal air-conditioning controls include, for example as described above, controlling the rotation speed of the ventilator 18 such that the airflow rate of the ventilator 18 becomes the set airflow rate of the airflow rate setting switch. In other words, while the blowout air switching device 24 is operated according to the determination result of S101, other devices, such as the blowout air switching device 24 and the heat exchanger 20, are operated independently of the determination result of S101.

Further, the processing at each step of FIG. 5 described above constitutes a unit that performs the corresponding function.

As described above, according to the present embodiment, the controller 26 causes the blowout air switching device 24 to switch the air blowout portion 321 to the above described first blowing state when the air being blown out from the air blowout portion 321 is in the above described pre-temperature controlled state. Meanwhile, the controller 26 causes the blowout air switching device 24 to switch the air blowout portion 321 to the above described second blowing state when the air being blown out from the air blowout portion 321 is in the above described temperature controlled state. In addition, in the first blowing state, as shown in FIG. 3, the first air outlet 321a is open while the second air outlet 321b is closed. Conversely, in the second blowing state, as shown in FIG. 4, the first air outlet 321a is closed while the second air outlet 321b is open. Accordingly, it is possible avoid blowing insufficiently temperature controlled air against a seated occupant without needing to suppress the blowout airflow rate when starting air-conditioning of the seat air-conditioner 10. For this reason, it is possible to avoid discomforting a seated occupant sitting on a vehicle seat.

Further, for example during rapid heating in which the vehicle cabin interior is rapidly heated, a sufficient airflow rate may be passed through the heat exchanger 20 without discomforting the seated occupant. Accordingly, it is possible to obtain sufficiently temperature controlled blowout air in a short time.

Further, according to the present embodiment, the first air outlet 321a is disposed in the tip portion of the blowout ventilation pipe 32. The first air outlet 321a blows out insufficiently temperature controlled air from the seat cushion 122 outward in the vehicle width direction DR1. Accordingly, when air is being blown out from the first air outlet 321a, substantially the entire length of the blowout ventilation pipe 32, which is cold and is the main cause of heat loss, may be heated. This entirely length of the blowout ventilation pipe 32 spans from a connection portion toward the heat exchanger 20 to the air blowout portion 321 at the opposite side. Due to this as well, for example during rapid heating, is possible to obtain sufficiently temperature controlled blowout air in a short time.

Further, according to the present embodiment, the ventilator 18 is able to draw in air-conditioned air, which has been temperature controlled by the vehicle cabin interior air-conditioner unit 16, through the intake ventilation pipe 28. Accordingly, seat air-conditioning may be performed using the air-conditioning abilities of the vehicle cabin interior air-conditioner unit 16.

### Second Embodiment

Next, a second embodiment of the present disclosure will be explained. The explanation will be focused on the points of the present embodiment which differ from the previously described first embodiment. Further, explanations of portions which are the same as, or equal to, the previous embodiment will be omitted or simplified. The same applies the third embodiment and onward, described later.

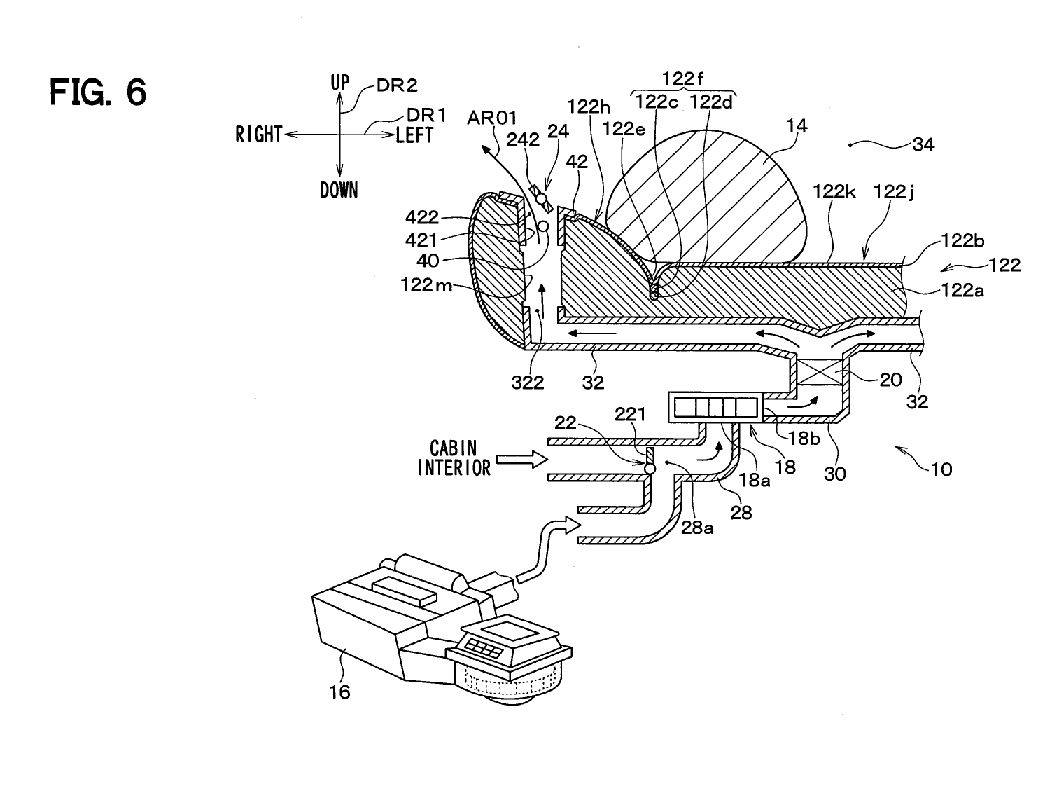

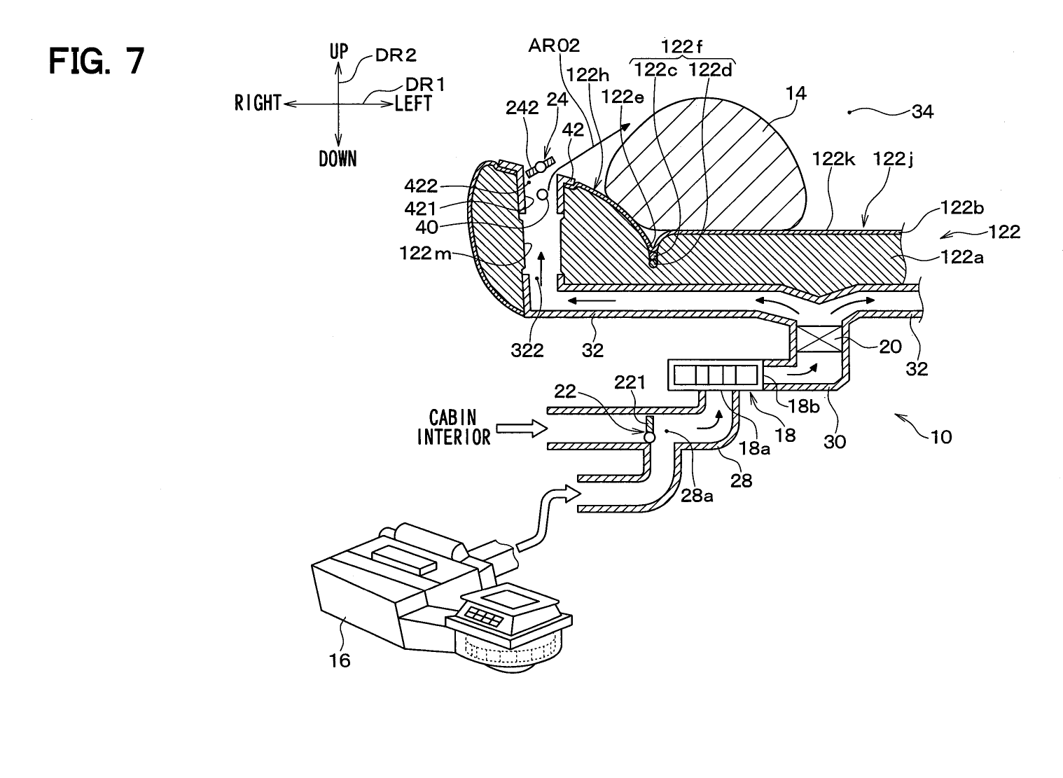

FIG. 6 is a cross sectional view of the seat air-conditioner 10 and the seat cushion 122 of the present embodiment, and corresponds to FIG. 3 of the first embodiment. FIG. 7 is a cross sectional view of the seat air-conditioner 10 and the seat cushion 122 of the present embodiment, and corresponds to FIG. 4 of the first embodiment. FIG. 7 is different from FIG. 6 in that the orientation of an air guide member 242 of the blowout air switching device 24 is different.

As shown in FIGS. 6 and 7, the blowout ventilation pipe 32 of the present embodiment does not wrap around the sides of the seat cushion 122, and the blowout ventilation pipe 32 does not have the air blowout portion 321 (refer to FIG. 3). An end portion 322 of the blowout ventilation pipe 32, which is at an opposite end from the heat exchanger 20 side, is connected from the bottom of the seat cushion 122 to a ventilation hole 122m formed in the seat cushion 122. The ventilation hole 122m of the seat cushion 122 penetrates until the seat surface, and opens at the right side seat peripheral portion 122h. The same applies to the left side seat peripheral portion 122i (refer to FIG. 2)

The seat air-conditioner 10 of the present embodiment includes a bezel 42. The bezel 42 is formed by an elastic member, such as rubber, which is elastic and which is harder than the seat cushion 122. A ventilation passage 421 is formed as a throughhole in the bezel 42. The bezel 42 is inserted into the top surface of the seat cushion 122, i.e., the seated occupant side, such that the ventilation passage 421 is connected to the ventilation hole 122m. An air blowout portion 422 is formed as an end portion of the bezel 42 and opens above the seat cushion 122. The air blowout portion 422 opens into the vehicle cabin interior and blows out air guided from the heat exchanger 20.

The blowout air switching device 24 of the present embodiment is arranged in the air blowout portion 422 of the bezel 42. In addition, the blowout air switching device 24 includes the air guide member 242 in place of the pivot door 241 of the first embodiment (refer to FIG. 3). The air guide member 242 is an air guiding plate that changes a blowing direction of the air being blown out from the air blowout portion 422. In a similar manner as the pivot door 241 of the first embodiment, the air guide member 242 is rotated by an actuator operated according to a control signal from the controller 26. The air guide member 242 is positioned in a first pivot position and a second pivot position. The first pivot position causes air to be blown outward of the seat cushion 122 in the vehicle width direction DR1, as shown by the arrow AR01 in FIG. 6. The second pivot position causes air to be blown in a diagonally upward direction toward the center seat portion 122j, as shown by the arrow AR02 in FIG. 7.

As shown in FIGS. 6 and 7, the blowout air switching device 24 changes the blowing direction of the air being blown out from the air blowout portion 422 by using the air guide member 242, which is positioned in the first pivot position or the second pivot position as described above. Due to this, the blowout air switching device 24 switches the air blowout portion 422 between a first blowing state, which blows air so as to avoid the passenger space 34, and a second blowing state, which blows air toward the passenger space 34. Specifically, when the air guide member 242 is positioned in the first pivot position as shown in FIG. 6, the air blowout portion 422 is in the first blowing state. Conversely, when the air guide member 242 is positioned in the second pivot position as shown in FIG. 7, the air blowout portion 422 is in the second blowing state.

As described above, according to the present embodiment, the air blowout portion 422 may be switched between the first blowing state and the second blowing state in a similar manner as the first embodiment. Due to this, the same effects as those of the first embodiment may be obtained.

### Third Embodiment

Next, a third embodiment of the present disclosure will be explained. The explanation will be focused on the points of the present embodiment which differ from the previously described first embodiment.

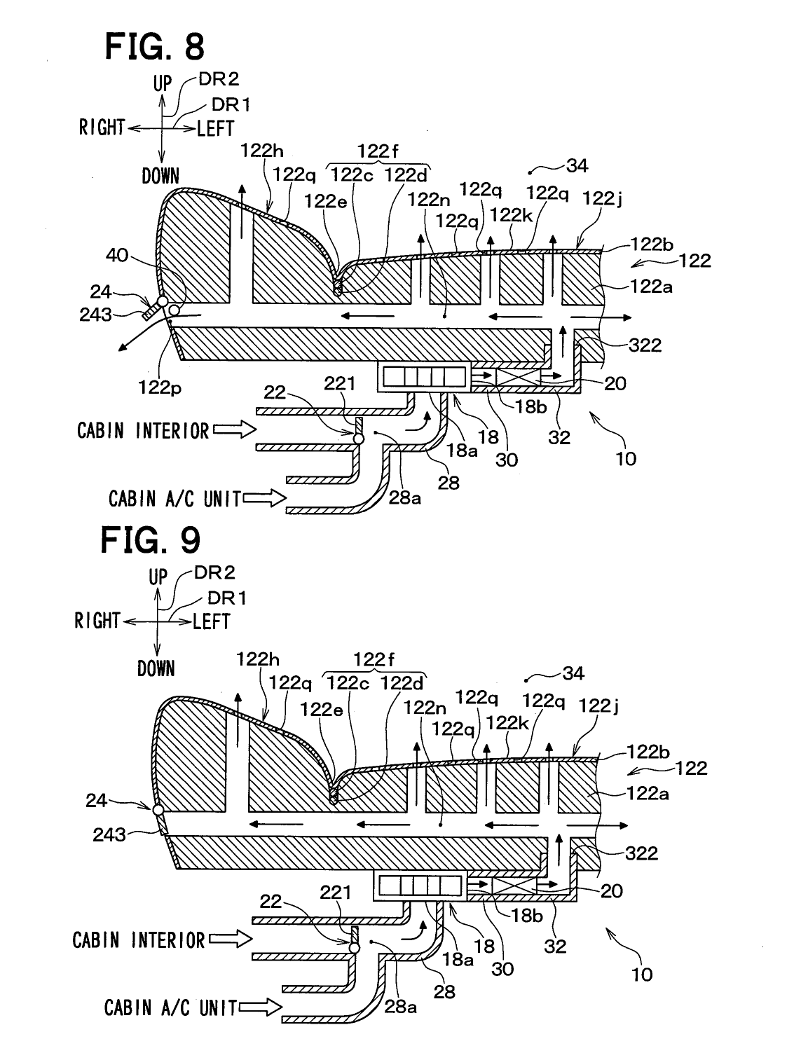

FIG. 8 is a cross sectional view of the seat air-conditioner 10 and the seat cushion 122 of the present embodiment, and corresponds to FIG. 3 of the first embodiment. FIG. 9 is a cross sectional view of the seat air-conditioner 10 and the seat cushion 122 of the present embodiment, and corresponds to FIG. 4 of the first embodiment. FIG. 8 is different from FIG. 9 in that the orientation of an opening and closing door 243 of the blowout air switching device 24 is different.

As shown in FIGS. 8 and 9, the blowout ventilation pipe 32 of the present embodiment does not wrap around the sides of the seat cushion 122, and the blowout ventilation pipe 32 does not have the air blowout portion 321 (refer to FIG. 3). An end portion 322 of the blowout ventilation pipe 32, which is at an opposite end from the heat exchanger 20 side, is connected from the bottom of the seat cushion 122 to a ventilation passage 122n formed in the seat pad 122a.

The ventilation passage 122n of the seat pad 122a branches within the seat pad 122a so as to deliver air from the heat exchanger 20 to the entire seat surface, and opens toward the seat cover 122b. Further, the seat cushion 122 includes an air outlet 122p in communication with the ventilation passage 122n. The air outlet 122p of the seat cushion 122 is in communication with the ventilation passage 122n, and thus is an aperture that blows out air guided from the heat exchanger 20. In addition, the air outlet 122p is formed in a portion other than the passenger support surface 122k. Specifically, the air outlet 122p is formed on a side surface of the seat cushion 122 facing the vehicle width direction DR1.

The seat cover 122b of the seat cushion 122, which includes the passenger support surface 122k, is a perforated cover that forms a plurality of micro holes 122q. The seat cover 122b may be formed by, for example, natural leather or artificial leather. Each of the micro holes 122q of the seat cover 122b is a ventilation hole with a diameter of about 1 mm, and blows out air, which is guided from the heat exchanger 20 through the ventilation passage 122n, toward a seated occupant. All of the plurality of micro holes 122q of the seat cushion 122 and the air outlet 122p together form an air blowout portion that opens into the vehicle cabin interior and blows out air guided from the heat exchanger 20.

The blowout air switching device 24 of the present embodiment is arranged in the air outlet 122p of the seat cushion 122. In addition, the blowout air switching device 24 includes an opening and closing door 243 in place of the pivot door 241 of the first embodiment (refer to FIG. 3). The opening and closing door 243 is a member that opens and closes the air outlet 122p, and similar to the pivot door 241 of the first embodiment, is rotated by an actuator operated according to a control signal from the controller 26. The opening and closing door 243 is positioned in an open position, which opens the air outlet 122p as shown in FIG. 8, and a closed position, which closes the air outlet 122p as shown in FIG. 9.

In addition, a ventilation resistance of blowing out air from the air outlet 122p of the seat cushion 122 is lower than a ventilation resistance of blowing out air from the plurality of micro holes 122q. For this reason, when the air outlet 122p is open, the air passing through the ventilation passage 122n of the seat pad 122a is not blown out from the plurality of micro holes 122q, and instead is entirely blown out from the air outlet 122p. Conversely, if the air outlet 122p is closed, the air passing through the ventilation passage 122n of the seat pad 122a is blown out from the plurality of micro holes 122q. In other words, when the blowout air switching device 24 switches an air blowout portion, which is formed from the air outlet 122p and the plurality of micro holes 122q, to a first blowing state which blows air so as to avoid the passenger space 34, the blowout air switching device 24 opens the air outlet 122p as shown in FIG. 8. Conversely, when the blowout air switching device 24 switches the air blowout portion to a second blowing state which blows toward the passenger space 34, the blowout air switching device 24 closes the air outlet 122p as shown in FIG. 9.

As described above, according to the present embodiment, the air blowout portion may be switched between the first blowing state and the second blowing state in a similar manner as the first embodiment. Due to this, the same effects as those of the first embodiment may be obtained.

### Fourth Embodiment

Next, a fourth embodiment of the present disclosure will be explained. The explanation will be focused on the points of the present embodiment which differ from the previously described first embodiment.

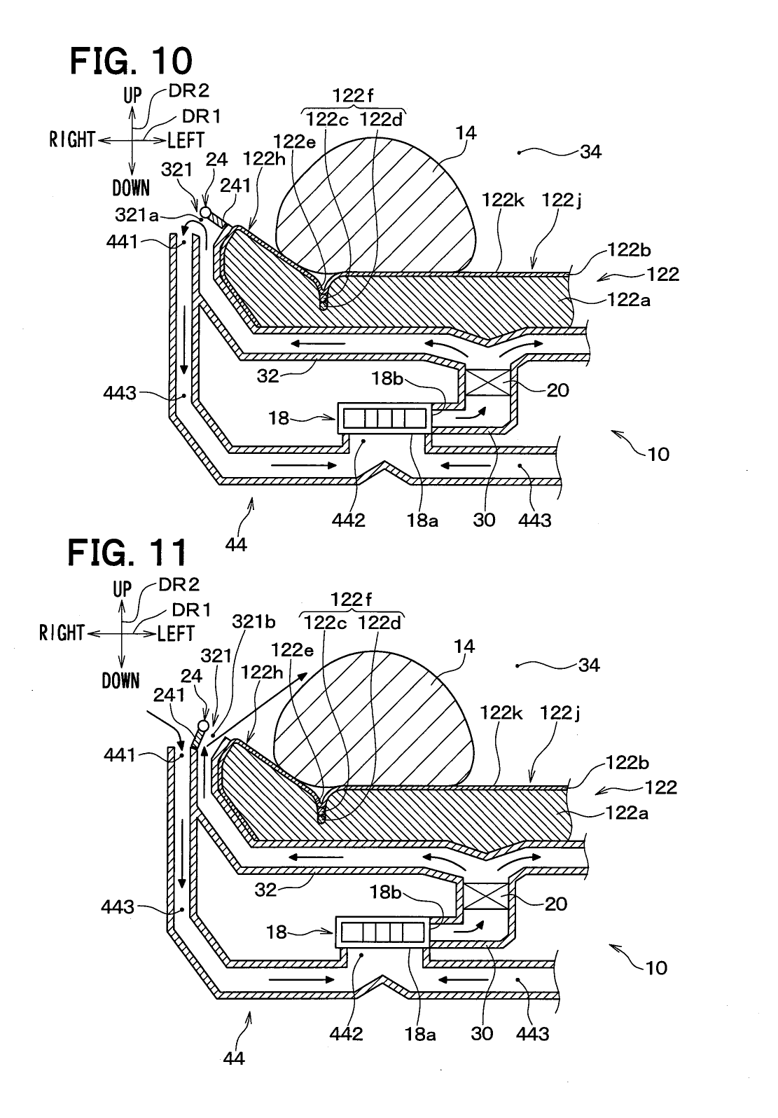

FIG. 10 is a cross sectional view of the seat air-conditioner 10 and the seat cushion 122 of the present embodiment, and corresponds to FIG. 3 of the first embodiment. FIG. 11 is a cross sectional view of the seat air-conditioner 10 and the seat cushion 122 of the present embodiment, and corresponds to FIG. 4 of the first embodiment. FIG. 11 is different from FIG. 10 in that the orientation of the pivot door 241 of the blowout air switching device 24 is different.

As shown in FIGS. 10 and 11, in the present embodiment, a member and a device disposed at the air intake side of the ventilator 18 is different with respect to the first embodiment, Specifically, the seat air-conditioner 10 of the present embodiment is different from the first embodiment, and includes an intake ventilation pipe 44 as a suction pipe portion that opens into the vehicle cabin interior. The intake ventilation pipe 44 includes air suction portions 441 that open into the vehicle cabin interior, an air outflow portion 442 connected to the air inlet 18a of the ventilator 18, and an airflow passage 443 that connects the air suction portion 441 with the air outflow portion 442.

The air suction portions 441 are formed as a pair arranged on either of the left and right sides of the seat cushion 122 in the vehicle width direction DR1. For this reason, the airflow passage 443 also branches so as to branch out from the air outflow portion 442. One end of the branched airflow passage 443 is connected to one of the air suction portions 441, while the other end of the branched airflow passage 443 is connected to the other one of the air suction portions 441.

Further, the air suction portion 441 is disposed adjacent the first air outlet 321a of the air blowout portion 321 so as to substantially suck in the air blown out form the first air outlet 321a.

Due to such a configuration of the intake ventilation pipe 44, the air outflow portion 442 discharges air, which is sucked in from the air suction portion 441, toward the air intake side of the ventilator 18. Further, the ventilator 18 sends the air sucked in from the intake ventilation pipe 44 toward the heat exchanger 20.

According to the present embodiment, the air blowout portion 321 may be switched between the first blowing state and the second blowing state in a similar manner as the first embodiment. Due to this, the same effects as those of the first embodiment may be obtained.

Further according to the present embodiment, as shown in FIG. 10, the air being blown out from the first air outlet 321a of the air blowout portion 321 is substantially sucked into the blowout ventilation pipe 32, so the air circulates while the air blowout portion 321 is in the first blowing state. Accordingly, it is possible to improve the effect of obtaining sufficiently temperature controlled air in a short time.

Further, the present embodiment may be combined with either of the second and third embodiments described previously. When combining the present embodiment with the second embodiment, for example, the air blowout portion 422 (refer to FIG. 6) may be arranged outward of the seat cushion 122, similar to the air blowout portion 321 of the first embodiment shown in FIG. 3.

### Fifth Embodiment

Next, a fifth embodiment of the present disclosure will be explained. The explanation will be focused on the points of the present embodiment which differ from the previously described fourth embodiment.

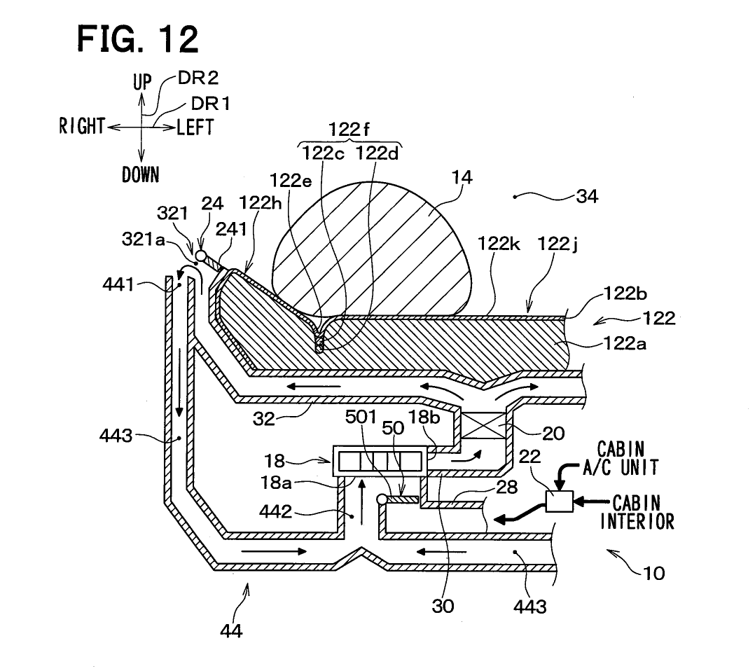

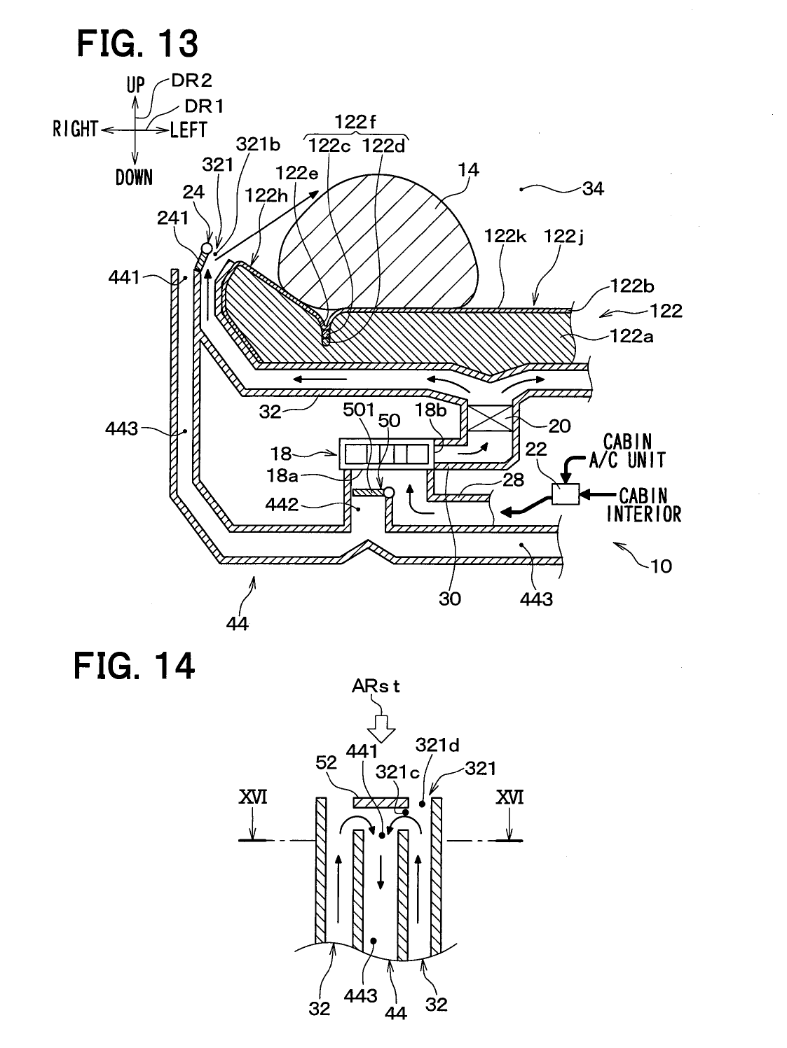

FIG. 12 is a cross sectional view of the seat air-conditioner 10 and the seat cushion 122 of the present embodiment, and corresponds to FIG. 10 of the fourth embodiment. FIG. 13 is a cross sectional view of the seat air-conditioner 10 and the seat cushion 122 of the present embodiment, and corresponds to FIG. 11 of the fourth embodiment.

As shown in FIGS. 12 and 13, according to the present embodiment, the air intake side of the ventilator 18 is different from the fourth embodiment. To be specific, in the fourth embodiment, the air inlet 18a of the ventilator 18 is only connected to the air outflow portion 442 of the intake ventilation pipe 44. In contrast, the seat air-conditioner 10 of the present embodiment includes the intake air switching device 22, the intake ventilation pipe 28, and an intake passage switching device 50. Further, one end of the intake ventilation pipe 28 and the air outflow portion 442 of the intake ventilation pipe 44 are both connected to the air inlet 18a of the ventilator 18 through the passage switching device 50.

The intake air switching device 22 and the intake ventilation pipe 28 of the present embodiment are the same as those of the previously described first embodiment, and are abbreviated from illustration in FIGS. 12 and 13. Accordingly, the intake air switching device 22 and the intake ventilation pipe 28 functions as an air inlet portion that introduces air from inside the vehicle cabin or air guided from the vehicle cabin interior air-conditioner unit 16.

The intake passage switching device 50 is disposed between the air inlet 18a of the ventilator 18, and the intake ventilation pipe 28 and the intake ventilation pipe 44. This intake passage switching device 50 includes a pivot door 501 and an actuator that rotates the pivot door 501 according to a control signal from the controller 26 (refer to FIG. 3).

The intake passage switching device 50 switches between a first connection state and a second connection state according to the orientation of the pivot door 501. In the first connection state, as shown in FIG. 12, the air outflow portion 442 of the intake ventilation pipe 44 is connected to the air inlet 18a of the ventilator 18, while the intake ventilation pipe 28 is blocked. In the second connection state, as shown in FIG. 13, the air outflow portion 442 of the intake ventilation pipe 44 is blocked, while the intake ventilation pipe 28 is connected to the air inlet 18a of the ventilator 18. In other words, the intake passage switching device 50 is a device that connects the air outflow portion 442 of the intake ventilation pipe 44 or the intake ventilation pipe 28 to the air inlet 18a of the ventilator 18, and corresponds to a second switching device of the present disclosure.

Further, the controller 26 of the present embodiment is configured, when switching the air blowout portion 321 of the blowout air switching device 24 to the above described first blowing state, to also cause the intake passage switching device 50 to connect the outflow portion 442 of the intake ventilation pipe 44 to the air inlet 18a of the ventilator 18.

Specifically, at S102 of FIG. 5, the controller 26 switches the air blowout portion 321 of the blowout air switching device 24 to the first blowing state and switches the intake passage switching device 50 to the above described first connection state, as shown in FIG. 12. Further, at S103 of FIG. 5, the controller 26 switches the air blowout portion 321 of the blowout air switching device 24 to the second blowing state and switches the intake passage switching device 50 to the above described second connection state, as shown in FIG. 13.

According to the present embodiment, the seat air conditioner 10 of the present embodiment includes the same configuration as that of the fourth embodiment. Accordingly, the same effects as the fourth embodiment may be obtained.

Further according to the present embodiment, the ventilator 18 is able to sucked in, through the intake ventilation pipe 28, air-conditioned air which has been temperature controlled by the vehicle cabin interior air-conditioner unit 16. Accordingly, seat air-conditioning may be performed by using the air-conditioning function of that vehicle cabin interior air-conditioner unit 16.

### Sixth Embodiment

Next, a sixth embodiment of the present disclosure will be explained. The explanation will be focused on the points of the present embodiment which differ from the previously described fifth embodiment.

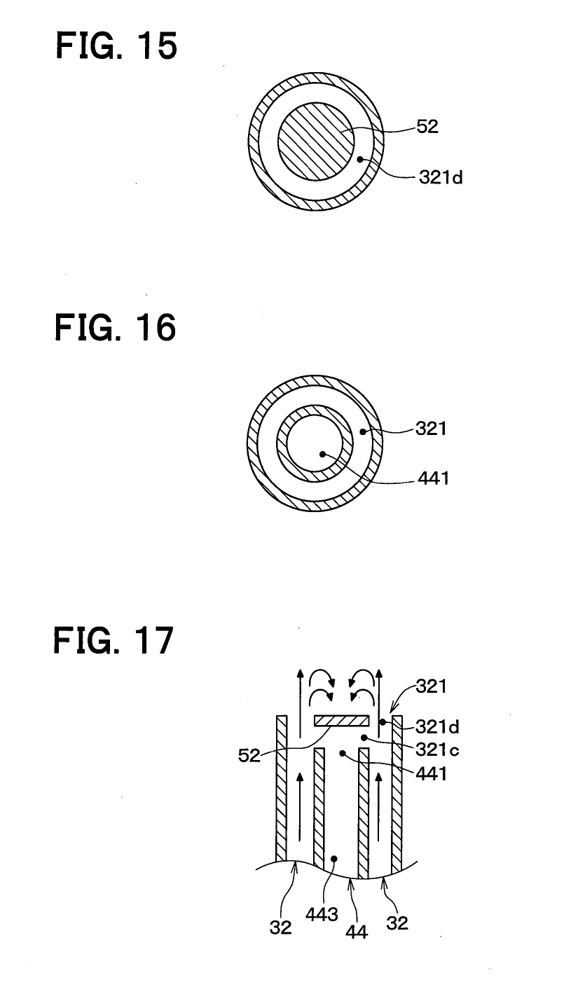

According to the present embodiment, as a point of difference with the fifth embodiment and as shown in FIGS. 14 to 16, the air blowout portion 321 of the blowout ventilation pipe 32 is integrally formed with the air suction portion 441 of the intake ventilation pipe 44. FIG. 14 is a cross sectional view shows the cross section of the air blowout portion 321 and the air suction portion 441 along the airflow. FIG. 15 is a plane view showing the air blowout portion 321 and the air suction portion 441 from the top side of FIG. 14. FIG. 16 is a cross sectional view along XVI-XVI of FIG. 14.

In addition, the arrows shown in FIG. 14 indicate the flow of air when the intake passage switching device 50 switches to the first connection state and a suction force of the ventilator 18 is applied to the airflow passage 443. Further, the air blowout portion 321 and the air suction portion 441 are formed as shown in FIGS. 14 to 16 on both the side and right sides of the seat cushion 122, to form a symmetrical shape with the seat cushion 122 interposed thereinbetween.

As shown in FIGS. 14 to 16, when viewing along the axial direction of the intake ventilation pipe 44, i.e., along the direction of the arrow ARst in FIG. 14, the air blowout portion 321 is formed in an annular shape so as to surround in the air suction portion 441. Then, the air blowout portion 321 and the air suction portion 441 are formed such that when the ventilator 18 is blowing and the intake passage switching device 50 switches to the first connection state (see FIG. 12), i.e., when the suction force of the ventilator 18 is applied to the intake ventilation pipe 44, air is sucked from the air blowout portion 321 into the air suction portion 441. The airflow at this time is shown by the arrows of FIG. 14.

In addition, the air blowout portion 321 and the air suction portion 441 are formed such that when the intake passage switching device 50 switches to the second connection state (see FIG. 13), i.e., when the intake ventilation pipe 44 is closed by the pivot door 501 and the suction force of the ventilator 18 is not applied to the intake ventilation pipe 44, air is blown out from the air blowout portion 321 toward the passenger space 34 (refer to FIG. 13).

Specifically, a first aperture 321c is formed on the interior of the annular air blowout portion 321. When the suction force of the ventilator 18 is applied to the intake ventilation pipe 44, blowout air from the air blowout portion 321 passes through the first aperture 321c and flows into the air suction portion 441 (see FIG. 14).

Further, when viewed along the direction of the arrow ARst of FIG. 14, an air shield plate 52 is disposed so as to cover the air suction portion 441. A second aperture 321d is formed in the air blowout portion 321 so as to open in the axial direction of the blowout ventilation pipe 32. This second aperture 321d is formed in an annular shape around the air shield plate 52. When the suction force of the ventilator 18 is not applied to the intake ventilation pipe 44 and air is being blown out from the air blowout portion 321, the blowout air from the air blowout portion 321 passes through the second aperture 321d and is blown out into the vehicle cabin interior (see FIG. 17). FIG. 17 is a cross sectional view of the air blowout portion 321 and the air suction portion 441 for showing the airflow at that time. Specifically, that airflow is shown by the arrows of FIG. 17.

As shown in FIG. 17, the blowout air from the air blowout portion 321 is blown out from the annular second aperture 321d. Accordingly, the air blowout portion 321 blows out air in an annular jet such that the inside airflow is slower than the outside airflow.

As shown in FIGS. 14 and 17, the seat air-conditioner 10 of the present embodiment does not include the blowout air switching device 24 corresponding to the first switching device of the present disclosure as in the fifth embodiment. But, according to the present embodiment, the intake passage switching device 50 (refer to FIG. 12) corresponds to the first switching device of the present disclosure. Then, the intake passage switching device 50 switches to the above described first connection state to change the air blowout portion 321 to the first blowing state in which air is blown in a direction away from the passenger space 34 (refer to FIG. 12), as shown in FIG. 14. Conversely, the intake passage switching device 50 switches to the above described second connection state to change the air blowout portion 321 to the second blowing state in which air is blown toward the passenger space 34, as shown in FIG. 17.

In addition, in the above described fifth embodiment, the intake passage switching device 50 corresponds to the second switching device of the present disclosure, but in the present embodiment, without having the intake passage switching device 50 correspond to the second switching device, a device corresponding to the second switching device may be not provided in the present embodiment.

According to the present embodiment, the seat air conditioner 10 of the present embodiment includes the same configuration as that of the fifth embodiment. Accordingly, the same effects as the fifth embodiment may be obtained.

Further according to the present embodiment, when the intake passage switching device 50 switches to the second connection state and the ventilator 18 is blowing air, the air blowout portion 321 blows out air in an annular shaped jet stream. Accordingly, by using the special characteristics of that annular shaped jet stream, the warm air may reach farther distances.

In addition, the present embodiment may be combined with the aforementioned fourth embodiment.

### Other Embodiments

(1) In each of the above described embodiments, the ventilator 18 is a centrifugal blower, but the ventilator 18 is not limited to this example and may be, for example, an axial flow type blower.

(2) In each of the above described embodiments, the heat exchanger 20 is, as an example, a PTC heater, but is not limited to an electric heater such as a PTC heater, and may be other types of heaters.

(3) In each of the above described embodiments, the seat air-conditioner 10 is an air-conditioner that blows out warm air, but may be an air-conditioner that blows out cool air as well. In this case, the heat exchanger 20 is not a heating heat exchanger, but is a cooling heat exchanger that cools air blown from the ventilator 18. The cooling heat exchanger may be, for example, formed of a Peltier element or the like. If the present disclosure is applied to a seat air-conditioner that blows cool air, it is possible to blow out sufficiently temperature controlled cool air in a short amount of time, and is especially effective during urgent cooling where the vehicle cabin interior is quickly cooled.

If the seat air-conditioner 10 is an air-conditioner that blows out cool air, then at S101 of FIG. 5, the controller 26 uses a temperature threshold T2spt, which is set by prior experimentation, in place of the temperature threshold T1spt explained in the first embodiment. In other words, the controller 26 determines that the air being blown out from the air blowout portion 321 is in the above described pre-temperature controlled state when the blowout air temperature Tspt is above the temperature threshold T2spt.

(4) In each of the above described embodiments, at S101 of FIG. 5, whether the air being blown out from the air blowout portion 321 is in the above described pre-temperature controlled state is determined based on the blowout air temperature Tspt, but may be determined based on other parameters instead. For example, if insufficiently temperature controlled air is blown out, the heat exchanger 20 has just started heating, and thus the controller 26 may use a timer for the determination at S101.

If a timer is used, the controller 26 determines that the air being blown out from the air blowout portion 321 is in the above described pre-temperature controlled state until a determination time TIME1, which is set by prior experimentation, elapses from the start of heating air by the heat exchanger 20. Then, once the determination time TIME1 elapses, the controller 26 determines that the air being blown out from the air blowout portion 321 is in the above described temperature controlled state. Further, the same applies to a modified example in which the heat exchanger 20 is a cooling heat exchanger. In this modified example, the air being blown out from the air blowout portion 321 is determined to be in the above described pre-temperature controlled state until the determination time TIME1 elapses from the start of cooling air by the heat exchanger 20.

(5) In the above described first to third, fifth, and sixth embodiments, air from inside the vehicle cabin or air from the vehicle cabin interior air-conditioner unit 16 is guided into the air inlet 18a of the ventilator 18, but only one of these may be guided into the air inlet 18a instead. In this case, the intake air switching device 22 is not needed.

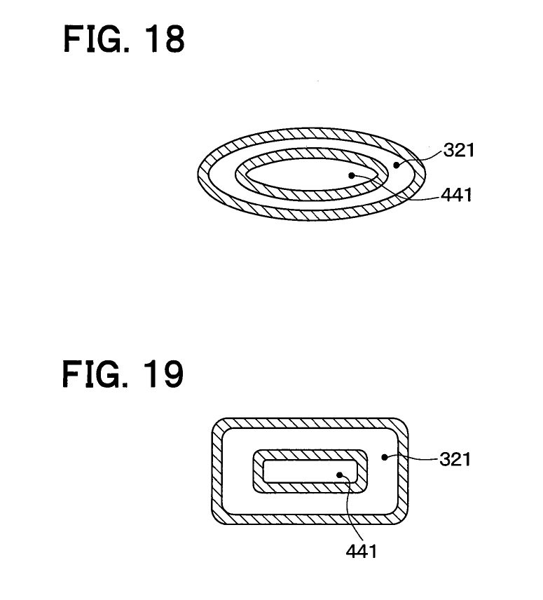

(6) In the above described sixth embodiment, in the XVI-XVI cross section of FIG. 14, the air blowout portion 321 and the air suction portion 441 are overall formed in a circular shape, but may be also be formed in an elliptical shape as shown in FIG. 18, or formed in a rectangular shape as shown in FIG. 19. FIG. 18 shows a first modified example corresponding to FIG. 16, which is a cross sectional view along XVI-XVI of FIG. 14. FIG. 19 shows a second modified example corresponding to FIG. 16.

(7) In the above described third embodiment, the seat cover 122b is, for example, made from natural leather or artificial leather, but may be a woven fabric such as moquette as well. In this case, the space between threads in the woven fabric function as the micro holes 122q.

(8) In each of the above described embodiments, the seat air-conditioner 10 is disposed in the seat cushion 122, but may be disposed in the seat back 121 as well.

(9) In the above described second embodiment, the ventilation hole 122m formed in the seat cushion 122 constitutes a portion of the ventilation passage of the seat air-conditioner 10. However, this is so that the ventilation passage can absorb deflections in the seat cushion 122, so instead of the ventilation hole 122m, a portion of the ventilation passage may be formed as bellows or by rubber piping or the like.

(10) In the above described first, second, and fourth to sixth embodiments, a total of two of the air blowout portions 321, 422 are disposed so as to form a pair in the left and right of the vehicle width direction DR1. However, it is possible to only dispose one of these two, without providing the other. This also applies to the air outlet 122p (refer to FIG. 8) of the third embodiment in the same way.

(11) In FIG. 6 of the above described second embodiment, the air blowout portion 422 is disposed in the seat peripheral portions 122h, 122i of the seat cushion 122, but may be disposed outward of the seat cushion 122 in the same manner as the air blowout portion 321 of FIG. 3.

(12) In each of the above described embodiments, when the air being blown out from the air blowout portion 321 is determined to be in the pre-temperature controlled state at S101 of FIG. 5, the ventilator 18 is controlled such that the airflow rate blown by the ventilator 18 becomes the set airflow rate set by the airflow rate setting switch. However, the airflow rate of the ventilator 18 may be controlled so as to exceed the set airflow rate by a predetermined amount. In this regard, as compared to when the airflow rate blown by the ventilator 18 is controlled to be the set airflow rate, the ventilation passage from the heat exchanger 20 to the air blowout portion 321 may warm up faster.

(13) In each of the above described embodiments, the processing of each step shown in FIG. 5 is performed by a computer program, but these may constitute hard logic as well.

Further, the present disclosure is not limited to the above described embodiments, and may be appropriately changed within the scope described in the scope of the claims. Further, needless to say, in each of the above described embodiments, the elements constituting each embodiment are not necessarily essential, except for elements which are specifically shows as being essential or are clearly essential on a fundamental level. Further, in each of the above described embodiments, in case a numerical value is described for a counting number, a value, an amount, a range or the like for a component element of an embodiment, these specific values are not limiting, except in the case in which a specific number liming is clearly described as being essential or is clearly essential on a fundamental level. Further, in each of the above described embodiments, if the material properties, shapes, positional relationships or the like of component elements of an embodiment are described, these material properties, shapes, positional relationships or the like are not limiting, except in the case in which a specific material property, shape, positional relationship or the like is clearly described as being essential or is clearly essential on a fundamental level.

What is claimed is:

1. A vehicle seat air-conditioner, comprising:
a ventilator that blows air;
a heat exchanger that heats or cools the air blown by the ventilator;
an air blowout portion that blows out air guided from the heat exchanger, the air blowout portion opening into a vehicle cabin;
a first switching device that switches the air blowout portion between
a first blowing state, in which air is blown from the air blowout portion so as to avoid a passenger space, the passenger space occupying above a passenger support surface of a vehicle seat that supports a sitting passenger, and
a second blowing state, in which air is blown from the air blowout portion toward the passenger space; and
a controller that
causes the first switching device to switch the air blowout portion to the first blowing state when the air blown from the air blowout portion is in a pre-temperature controlled state of prior to reaching a predetermined temperature controlled state, and
causes the first switching device to switch the air blowout portion to the second blowing state when the air blown from the air blowout portion is in the temperature controlled state.

2. The vehicle seat air-conditioner of claim 1, wherein
the air blowout portion includes a first air outlet and a second air outlet that are opened and closed by the first switching device and that blow out air, the first blowing state being achieved by opening the first air outlet, the second blowing state being achieved by opening the second air outlet.

3. The vehicle seat air-conditioner of claim 1, wherein
the first switching device includes an air guide member that changes a blowing direction of the air blown out from the air blowout portion, the switching between the first blowing state and the second blowing state being performed by changing the blowing direction of the air with the air guide member.

4. The vehicle seat air-conditioner of claim 1, wherein
the air blowout portion includes
a plurality of micro holes formed in the passenger support surface of the vehicle seat, the plurality of micro holes blowing out air guided from the heat exchanger, and
an air outlet formed in a portion other than the passenger support surface, the air outlet blowing out air guided from the heat exchanger,
a ventilation resistance when blowing out air from the air outlet is smaller than a ventilation resistance when blowing out air from the plurality of micro holes, and
the first switching device opens the air outlet when switching the air blowout portion to the first blowing state, and closes the air outlet when switching the air blowout portion to the second blowing state.

5. The vehicle seat air-conditioner of claim 1, further comprising:
an suction pipe portion that includes
an air suction portion disposed adjacent to the air blowout portion so as to suck in the air blown out from the air blowout portion in the first blowing state, the air suction portion opening into the vehicle cabin,
an air outflow portion that discharges the air, which was sucked in by the air suction portion, toward an air intake side of the ventilator, and
an airflow passage that connects the air suction portion with the air outflow portion.

6. The vehicle seat air-conditioner of claim 5, further comprising:
an air inlet portion that introduces air from inside the vehicle cabin or air guided from a vehicle cabin interior air-conditioner unit disposed separately from the vehicle seat; and
a second switching device that switches the connection of the air intake side of the ventilator between the air outflow portion of the suction pipe portion and the air inlet portion, wherein
the controller
causes the second switching device to connect the air intake side of the ventilator to the air outflow portion of the suction pipe portion when causing the first switching device to switch the air blowout portion to the first blowing state, and
causes the second switching device to connect the air intake side of the ventilator to the air inlet portion when causing the first switching device to switch the air blowout portion to the second blowing state.

7. The vehicle seat air-conditioner of claim 1, further comprising:
an suction pipe portion that includes
an air suction portion disposed adjacent to the air blowout portion so as to suck in the air blown out from the air blowout portion in the first blowing state, the air suction portion opening into the vehicle cabin,
an air outflow portion that discharges the air, which was sucked in by the air suction portion, toward an air intake side of the ventilator, and
an airflow passage that connects the air suction portion with the air outflow portion, wherein
the air blowout portion is formed in an annular shape so as to surround the air suction portion on the outer side of the air suction portion, and
the air blowout portion and the air suction portion are integrally formed, such that when a suction force of the ventilator is applied to the suction pipe portion, air is sucked from the air blowout portion to the air suction portion.

8. The vehicle seat air-conditioner of claim 7, wherein
the air blowout portion blows out air to form an annular jet stream where an inside airflow is slower than an outside airflow.

9. The vehicle seat air-conditioner of claim 7, further comprising:
an air inlet portion that introduces air from inside the vehicle cabin or air guided from a vehicle cabin interior air-conditioner unit disposed separately from the vehicle seat, wherein
the first switching device connects one of the air outflow portion of the suction pipe portion and the air inlet portion to the air intake side of the ventilator, and closes the other, and
the controller
causes the first switching device to switch the air blowout portion to the first blowing state by causing the first switching device to connect the air outflow portion of the suction pipe portion to the air intake side of the ventilator, and
causes the first switching device to switch the air blowout portion to the second blowing state by causing the first switching device to close the air outflow portion of the suction pipe portion.

10. The vehicle seat air-conditioner of claim 1, wherein
the heat exchanger is a heating heat exchanger that heats air, and
the controller determines that the air blown out from the air blowout portion is in the pre-temperature controlled state when a temperature of the air blown out from the air blowout portion is lower than a predetermined temperature threshold.

11. The vehicle seat air-conditioner of claim 1, wherein
the heat exchanger is a cooling heat exchanger that cools air, and
the controller determines that the air blown out from the air blowout portion is in the pre-temperature controlled state when a temperature of the air blown out from the air blowout portion is higher than a predetermined temperature threshold.

12. The vehicle seat air-conditioner of claim 1, wherein
the controller determines that the air blown out from the air blowout portion is in the pre-temperature controlled state until a predetermined determination time elapses from a start of heating or a start of cooling by the heat exchanger.
